(19) United States
(12) Patent Application Publication
(10) Pub. No.: US 2026/0121467 A1
(43) Pub. Date: Apr. 30, 2026

(54) MANUFACTURING APPARATUS FOR ROTOR OF ROTARY ELECTRIC MACHINE AND METHOD OF MANUFACTURING ROTOR

(71) Applicant: HONDA MOTOR CO., LTD., Tokyo (JP)

(72) Inventors: Naoki ITO, Tokyo (JP); Katsuhiko IWAZAWA, Tokyo (JP); Masashi KUSHITANI, Tokyo (JP); Yosuke HONDA, Tokyo (JP); Shoma OKUBO, Tokyo (JP)

(21) Appl. No.: 19/366,540

(22) Filed: Oct. 23, 2025

(30) Foreign Application Priority Data
Oct. 24, 2024 (JP) 2024-187223

(51) Int. Cl. H02K 1/276; H02K 15/035

(52) U.S. Cl. CPC H02K 1/276; H02K 15/035

(57) ABSTRACT

A rotor of a rotary electric machine includes a plurality of magnet insertion holes that penetrate in an axial direction and a magnet that is inserted into a corresponding one of the plurality of magnet insertion holes. The magnet includes a first chamfered portion formed by chamfering a corner where a first lateral surface, among a plurality of lateral surfaces arranged along the axial direction of the rotor, intersects one end surface in the axial direction, and a second chamfered portion formed by chamfering a corner where a second lateral surface, which is arranged adjacent to the first lateral surface among the plurality of lateral surfaces arranged along the axial direction of the rotor, intersects the one end surface in the axial direction.

This application is based on and claims the benefit of priority from Japanese Patent Application No. 2024-187223, filed on 24 Oct. 2024, the content of which is incorporated herein by reference.

### BACKGROUND OF THE INVENTION

### Field of the Invention

The present invention relates to a manufacturing apparatus for a rotor of a rotary electric machine and a method of manufacturing the rotor.

### Related Art

Conventionally known examples of techniques for manufacturing a rotor of a rotary electric machine include: a technique in which a magnet inserted into a magnetizing jig is fitted to an end portion of the rotor, and the magnet is pushed out from the magnetizing jig and transferred into a magnet insertion hole of the rotor (see, for example, Patent Document 1); and a technique in which a magnet is inserted into a magnet insertion hole of the rotor and a resin composition is further filled into the magnet insertion hole (see, for example, Patent Document 2).

Patent Document 1: Japanese Unexamined Patent Application, Publication No. 2004-270544

Patent Document 2: Japanese U.S. Pat. No. 7,451,829

### SUMMARY OF THE INVENTION

A rotor of a rotary electric machine is formed by stacking a plurality of thin electromagnetic steel sheets. Since a magnet insertion hole is formed to penetrate the stacked electromagnetic steel sheets, an inner wall surface of the magnet insertion hole is not necessarily a flat surface over the entire length, and may include fine step portions due to slight positional misalignment of the electromagnetic steel sheets. Therefore, it is necessary to secure a sufficient gap between the inner wall surface of the magnet insertion hole and the lateral surface of the inserted magnet to facilitate the insertion of the magnet.

However, when the gap between the magnet insertion hole and the lateral surface of the magnet is increased, variation may occur in the position of the magnet with respect to the magnet insertion hole. As a result, variation with respect to a standard value may occur in a magnetic flux state generated during operation of the rotary electric machine, potentially leading to individual differences. On the other hand, when the gap between the magnet insertion hole and the lateral surface of the magnet is reduced, there is a concern that the magnet cannot be inserted into the magnet insertion hole due to problems such as dimensional tolerances of the magnet and the magnet insertion hole, positional reproducibility between the two, and deterioration in stability due to interference.

An object of the present invention is to provide a rotor of a rotary electric machine and a method of manufacturing the rotor, in which a magnet can be automatically inserted into a magnet insertion hole, even if a gap between the magnet insertion hole and the magnet is small.

(1) A rotor (e.g., a rotor 3 described later) of a rotary electric machine (e.g., a rotary electric machine 1 described later) includes a plurality of magnet insertion holes (e.g., magnet insertion holes 33 described later) that penetrate in an axial direction and a magnet (e.g., a magnet 34 described later) that is inserted into a corresponding one of the plurality of magnet insertion holes. The magnet includes: a first chamfered portion (e.g., a first chamfered portion 34a described later) formed by chamfering a corner (e.g., a corner C1 described later) where a first lateral surface (e.g., a first lateral surface 341 described later), among a plurality of lateral surfaces arranged along an axial direction of the rotor, intersects one end surface in the axial direction (e.g., an end surface 343 described later); and a second chamfered portion (e.g., a second chamfered portion 34b described later) formed by chamfering a corner (e.g., a corner C2 described later) where a second lateral surface (e.g., a second lateral surface 342 described later), which is adjacent to the first lateral surface among the plurality of lateral surfaces, intersects the one end surface in the axial direction.

According to the above (1), since the first chamfered portion and the second chamfered portion are formed in the magnet, the magnet can be smoothly inserted into the magnet insertion hole, and can be automatically inserted into the magnet insertion hole with high positional accuracy.

Therefore, even if a gap between the magnet and the magnet insertion hole is small, a rotor can be configured such that the magnet can be easily inserted into the magnet insertion hole. Since it is sufficient to form two chamfered portions in the magnet, the number of processing steps and the processing cost for the magnet can also be reduced.

(2) In the rotor of the rotary electric machine as described in the above (1), a chamfering amount of the first chamfered portion and the second chamfered portion is greater than a protruding amount of a step portion formed on an inner wall surface of the magnet insertion hole.

According to the above (2), even if a step portion is present inside the magnet insertion hole when the magnet is inserted into the magnet insertion hole, the magnet can easily pass over the step portion, and the insertability of the magnet is excellent.

(3) A method of manufacturing a rotor is provided. The rotor includes a plurality of magnet insertion holes (e.g., a magnet insertion hole 33 described later) that penetrate in an axial direction and a magnet (e.g., a magnet 34 described later) that is inserted into a corresponding one of the plurality of magnet insertion holes. The magnet includes: a first chamfered portion (e.g., a first chamfered portion 34a described later) formed by chamfering a corner (e.g., a corner C1 described later) where a first lateral surface (e.g., a first lateral surface 341 described later), among a plurality of lateral surfaces arranged along an axial direction of the rotor, intersects one end surface in an axial direction (e.g., an end surface 343 described later); and a second chamfered portion (e.g., a second chamfered portion 34b described later) formed by chamfering a corner (e.g., a corner C2 described later) where a second lateral surface (e.g., a second lateral surface 342 described later), which is adjacent to the first lateral surface among the plurality of lateral surfaces, intersects the one end surface in the axial direction. The method includes a positioning step of positioning the magnet using a positioning jig (e.g., a positioning jig 130 described later), the positioning being based on reference surfaces defined by two inner surfaces (e.g., inner surfaces 131 and 132 described later) that contact the first and second lateral surfaces of the magnet; an alignment step of aligning the reference surfaces of the positioning jig, after the magnet has been positioned therein, with positions of two adjacent sides (e.g., sides 331 and 332 described later) of an opening (e.g., an opening 33a described later) of the magnet insertion hole; and an insertion step of pushing the magnet from the positioning jig and inserting the magnet into the magnet insertion hole, in a state where the positions of the reference surfaces of the positioning jig match the positions of the two sides of the opening.

According to the above (3), since the magnet including the first chamfered portion and the second chamfered portion can be automatically and smoothly inserted into the magnet insertion hole by movement in only one direction, in a state where the magnet is aligned with the two sides of the magnet insertion hole, a range of positional deviation of the magnet relative to the magnet insertion hole is reduced. Therefore, even if a gap between the magnet insertion hole and the magnet is small, the magnet can be easily inserted into the magnet insertion hole. Since it is sufficient to form the two chamfered portions in the magnet, processing effort and cost can also be reduced.

(4) In the method of manufacturing a rotor as described in the above (3), a chamfering amount of the first chamfered portion and the second chamfered portion is greater than a protruding amount of a step portion formed on an inner wall surface of the magnet insertion hole.

According to the above (4), even if a step portion is present inside the magnet insertion hole when the magnet is inserted into the magnet insertion hole, the magnet can easily pass over the step portion, and the insertability of the magnet is excellent.

(5) In the method of manufacturing a rotor as described in the above (3) or (4), in the positioning step, the magnet is supported in the positioning jig by pressing the magnet against the two inner surfaces of the positioning jig using a support device (e.g., a support device 160 described later).

According to the above (5), the support device can support the magnet in a state where the magnet is positioned with respect to the two inner surfaces of the positioning jig.

(6) In the method of manufacturing a rotor as described in the above (5), in the positioning step, the magnet is elastically pressed against the two inner surfaces of the positioning jig using the support device.

According to the above (6), since the support device can absorb displacement of the magnet when the magnet passes over the step portion in the magnet insertion hole, the magnet can smoothly pass over the step portion without compromising the supported state.

(7) In the method of manufacturing a rotor as described in the above (5) or (6), in the positioning step, the magnet is pressed against the two inner surfaces of the positioning jig by bringing the support device into point contact or line contact with the magnet.

According to the above (7), the magnet can be stably pressed against the two inner surfaces of the positioning jig.

(8) In the method of manufacturing a rotor as described in any one of the above (5) to (7), in the positioning step, different pressing forces are applied to the first lateral surface and the second lateral surface of the magnet against the two inner surfaces of the positioning jig, respectively.

According to the above (8), the magnet can be reliably brought into contact with the two inner surfaces of the positioning jig and can be stably positioned.

(9) In the method of manufacturing a rotor according to any one of the above (5) to (8), in the insertion step, a distal end portion of the support device is rotated in accordance with movement of the magnet pushed toward the magnet insertion hole.

According to the above (9), when the magnet is inserted into the magnet insertion hole, the support device does not create resistance and allows smooth insertion.

According to the present invention, it is possible to provide a rotor of a rotary electric machine and a method of manufacturing the rotor, in which a magnet can be automatically inserted into a magnet insertion hole even if a gap between the magnet insertion hole and the magnet is small.

### BRIEF DESCRIPTION OF THE DRAWINGS

FIG. 1 is a sectional view of a rotary electric machine;

FIG. 2 is a sectional view of a rotor;

FIG. 3 is a configuration diagram illustrating an overview of a manufacturing apparatus for a rotor according to the present embodiment;

FIG. 4 is a side view of a principal part of the manufacturing apparatus for a rotor according to the present embodiment;

FIG. 5 is a plan view of a principal part of the manufacturing apparatus for a rotor according to the present embodiment;

FIG. 6 is a schematic diagram for explaining a relationship between a positioning jig and an opening position acquisition device in the manufacturing apparatus for a rotor according to the present embodiment;

FIG. 7 is a block diagram of the manufacturing apparatus for a rotor according to the present embodiment;

FIG. 8 is a diagram illustrating an opening of a magnet insertion hole;

FIG. 9 is a perspective view of the magnet;

FIG. 10 is a diagram illustrating the magnet positioned in the positioning jig of the manufacturing apparatus for a rotor, as viewed from below the positioning jig;

FIG. 11 is a diagram illustrating a rake angle and a rake amount of a chamfered portion of the magnet;

FIG. 12 is a diagram illustrating a state in which the magnet in FIG. 9 is inserted into the magnet insertion hole, in a state where the magnet is positioned in the positioning jig;

FIG. 13 is a flowchart for explaining the method of manufacturing a rotor according to the present embodiment;

FIG. 14 is a plan view illustrating a state in which a magnet is positioned in the positioning jig;

FIG. 15 is a diagram illustrating a state in which the positions of the reference surfaces of the magnet match the positions of two sides of the opening of the magnet insertion hole;

FIG. 16 is a side view illustrating a state in which the magnet in the positioning jig is positioned in the magnet insertion hole of the rotor;

FIG. 17 is a side view illustrating an aspect of inserting the magnet of the positioning jig into the magnet insertion hole of the rotor;

FIG. 18 is a side view illustrating an aspect of inserting the magnet of the positioning jig into the magnet insertion hole of the rotor;

FIG. 19 is a side view illustrating an aspect of inserting the magnet of the positioning jig into the magnet insertion hole of the rotor; and

FIG. 20 is a side view illustrating another example of the chamfered portion of the magnet.

### DETAILED DESCRIPTION OF THE INVENTION

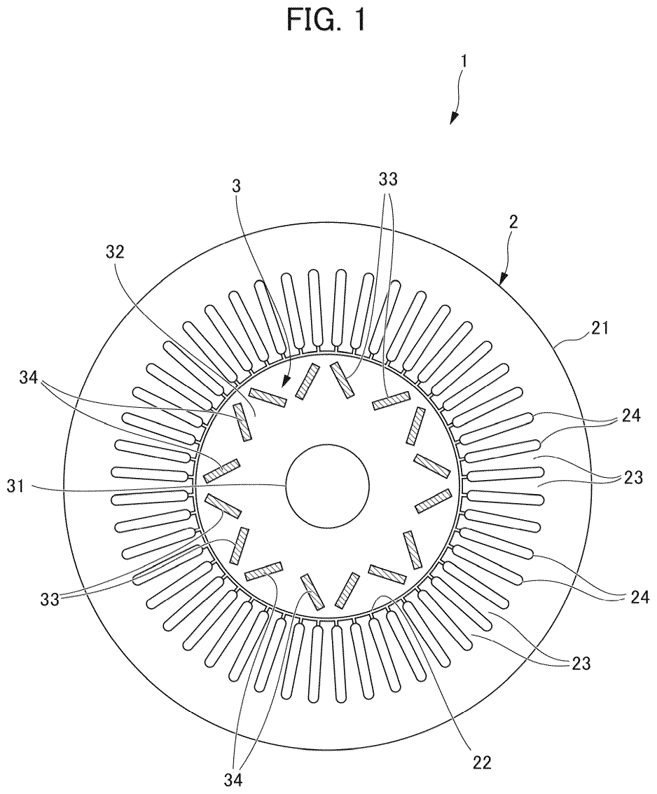

Hereinafter, embodiments of the present invention will be described in detail with reference to the drawings. As illustrated in FIG. 1, a rotary electric machine 1 includes a stator 2 and a rotor 3.

The stator 2 includes a stator core 21 formed of a laminate of a plurality of thin electromagnetic steel sheets. The stator core 21 includes: a shaft hole 22 that penetrates the center thereof in the axial direction (perpendicular to the plane of FIG. 1); a plurality of teeth 23 that are arranged radially around the shaft hole 22; and a plurality of slots 24 formed between adjacent teeth 23 in a circumferential direction, each of the slots 24 being open toward both end surfaces of the shaft hole 22 and the stator core 21 in the axial direction. A coil is inserted into each slot 24, although the coils are omitted in FIG. 1.

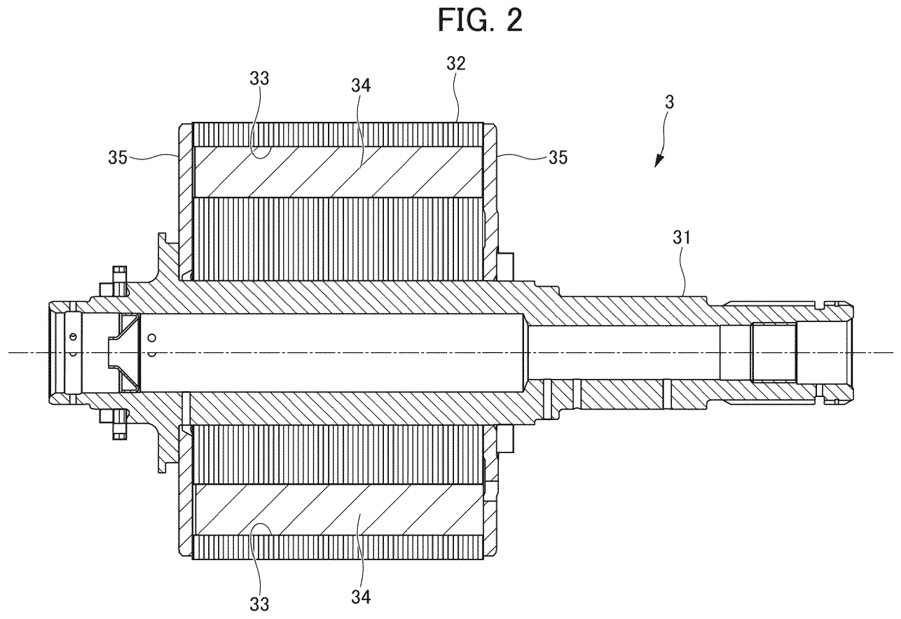

As illustrated in FIGS. 1 and 2, the rotor 3 includes a rotary shaft 31 and a rotor core 32 provided in a cylindrical shape on an outer circumferential surface of the rotary shaft 31. The rotary shaft 31 is rotatably supported in the shaft hole 22 of the stator 2. The rotor core 32 is formed of a laminate of a plurality of thin electromagnetic steel sheets and is arranged in the shaft hole 22 so that an outer circumferential surface thereof is in proximity to the teeth 23 of the stator core 21.

As illustrated in FIGS. 1 and 2, a plurality of magnet insertion holes 33 are provided in the rotor core 32 along a circumferential direction of the rotor core 32. Each of the magnet insertion holes 33 is formed so as to penetrate in the axial direction of the rotor core 32 (perpendicular to the plane of FIG. 1, and in the horizontal direction in FIG. 2), and opens in a rectangular shape at both end surfaces of the rotor core 32 in the axial direction. In the present embodiment, eight pairs of magnet insertion holes 33, each pair arranged in a V-shape, are provided along the circumferential direction of the rotor core 32. However, the number and arrangement of the magnet insertion holes 33 are not particularly limited.

A rectangular parallelepiped magnet 34 is inserted into each of the magnet insertion holes 33. A cross-sectional shape of the magnet 34 along a direction orthogonal to the axial direction of the rotor core 32 is formed substantially rectangular in conformity with an opening shape of the magnet insertion hole 33. As illustrated in FIG. 2, end plates 35 are provided at both end surfaces of the rotor core 32 in the axial direction, in which the magnets 34 are inserted into the magnet insertion holes 33, and the end plates 35 seal the magnet insertion holes 33. Details of the specific configuration of the magnet 34 will be further described later.

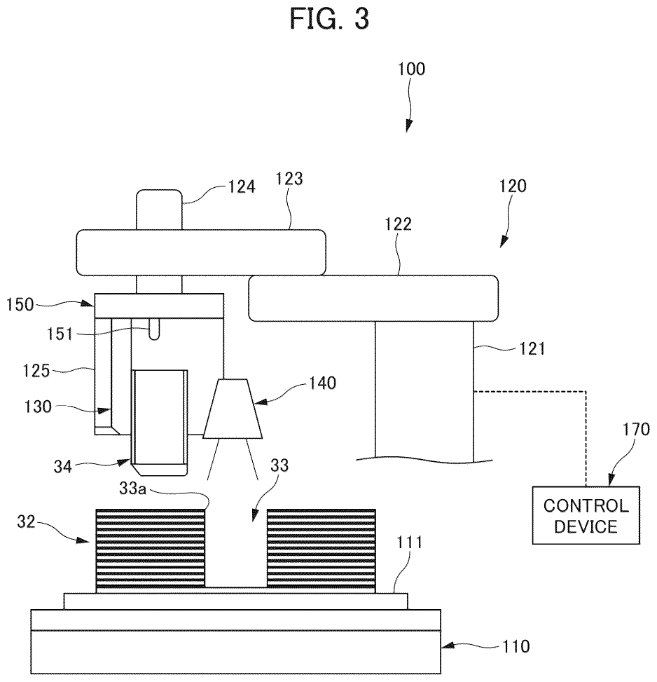

Next, a manufacturing apparatus 100 configured to insert the magnets 34 into the magnet insertion holes 33 of the rotor core 32 will be described with reference to FIGS. 3 to 8. The manufacturing apparatus 100 includes: a placement table 110 on which the rotor core 32 is placed; a robot 120; a positioning jig 130; an imaging device 140; a pushing device 150; a support device 160; and a control device 170.

The placement table 110 includes a placement surface 111 on which the rotor core 32 before insertion of the magnets 34 is placed. The rotor core 32 is placed and immovably supported on the placement table 110 so that the axial direction of the rotor core 32 is perpendicular to the placement surface 111.

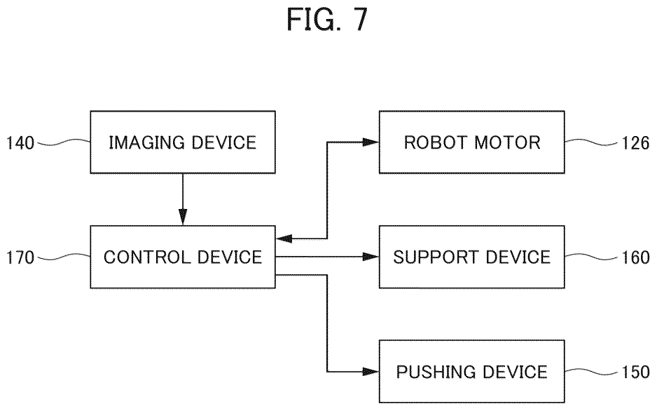

The robot 120 is a transport device that movably includes a first arm 122, a second arm 123, and a third arm 124. The first arm 122 is rotatably provided in the horizontal direction at the upper end of a first shaft 121 provided on a base (not illustrated). The second arm 123 is horizontally rotatably connected to the distal end of the first arm 122. The third arm 124 is vertically movably provided at the distal end of the second arm 123. A mounting base 125 is attached to the lower end portion of the third arm 124. The first arm 122, the second arm 123, and the third arm 124 operate by the drive of a robot motor 126 (see FIG. 7), and move the mounting base 125 to any position in the horizontal and vertical directions over the placement table 110. The positioning jig 130, the imaging device 140, pushing device 150, and the support device 160 described later are all mounted on the mounting base 125.

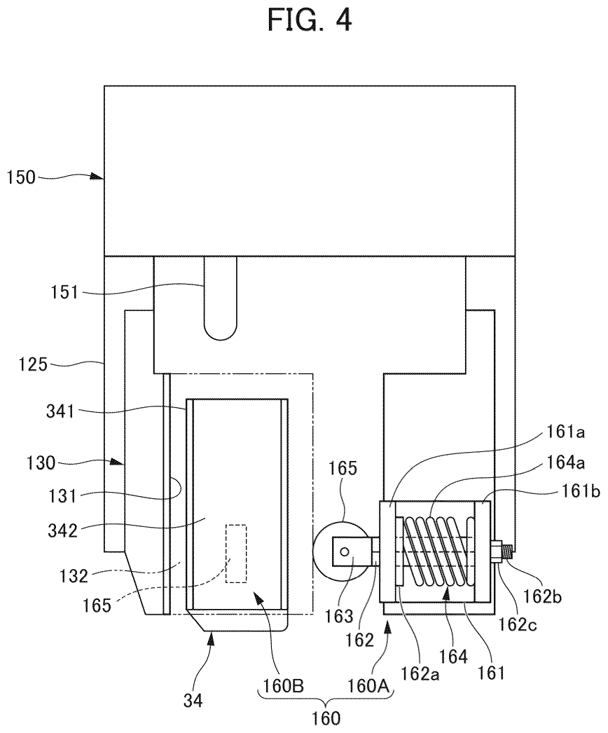

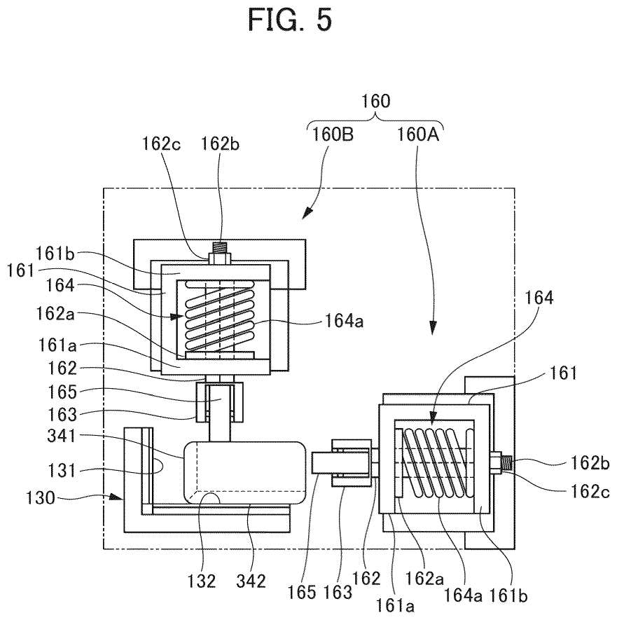

As illustrated in FIG. 5, the positioning jig 130 is made of a metal member formed in an L-shape when viewed in plan view. The magnet 34, which has a square cross-section, includes two adjacent lateral surfaces: a first lateral surface 341 and a second lateral surface 342, which are arranged along the insertion direction when the magnet 34 is inserted into the magnet insertion hole 33 of the rotor core 32 in the axial direction of the rotor 3. The first lateral surface 341 and the second lateral surface 342 intersect at a right angle. The positioning jig 130 includes two inner surfaces 131 and 132 that respectively contact the first lateral surface 341 and the second lateral surface 342 of the magnet 34. The two inner surfaces 131 and 132 intersecting at a right angle are arranged along the insertion direction of inserting the magnet 34 into the magnet insertion hole 33 of the rotor core 32. The two inner surfaces 131 and 132 serve as reference surfaces for positioning the magnet 34. The positioning jig 130 is fixed to the mounting base 125 in a posture such that the planar directions of the two inner surfaces 131 and 132 (the vertical direction in FIG. 4, and the direction perpendicular to the plane of FIG. 5) are arranged perpendicular to the placement surface 111 of the placement table 110.

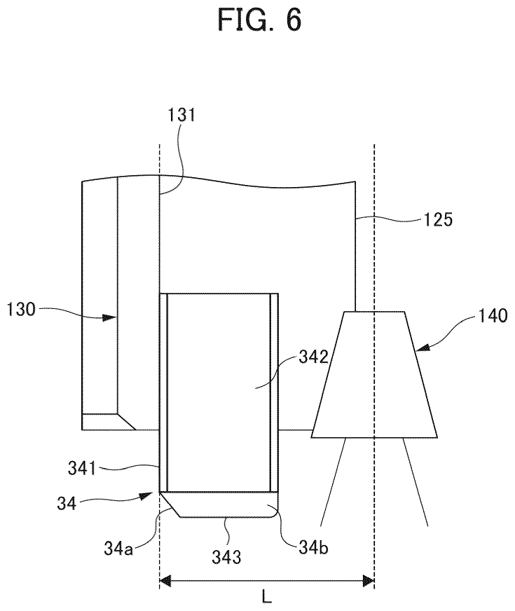

The imaging device 140 is configured, for example, with a camera capable of capturing two-dimensional images. The imaging device 140 individually captures images of positions of the magnet insertion holes 33 of the rotor core 32 placed on the placement surface 111 of the placement table 110. The imaging device 140, in cooperation with the control device 170 described later, configures an opening position acquisition device that acquires position information of the openings 33a of the magnet insertion holes 33. The position information of each opening 33a is information on positions of two sides that intersect at a right angle in the rectangular opening 33a of the magnet insertion hole 33. The imaging device 140 is fixed to the mounting base 125 so as to be able to capture images downward. As illustrated in FIG. 6, the imaging device 140 is arranged at a predetermined horizontal distance L from the positioning jig 130. That is, the position of the imaging device 140 with respect to the positioning jig 130 is defined by the fixed and unchanging distance L.

As illustrated in FIGS. 3 and 4, the pushing device 150 is fixed on the mounting base 125 above the positioning jig 130. The pushing device 150 includes a pushing pin 151 that can project downward. The pushing pin 151 is driven downward by operation of a drive source such as an actuator (not illustrated) and pushes the magnet 34 downward, which is positioned by the positioning jig 130

As illustrated in FIGS. 4 and 5, the support device 160 includes a first support device 160A and a second support device 160B. The first support device 160A and the second support device 160B are arranged on the same horizontal plane of the mounting base 125, with their movement directions oriented orthogonally to each other. Specifically, as illustrated in FIG. 5, the first support device 160A is arranged near the positioning jig 130 so as to face one inner surface 131 of the positioning jig 130, and the second support device 160B is arranged near the positioning jig 130 so as to face the other inner surface 132 of the positioning jig 130. The first support device 160A is configured to be movable forward and backward toward the one inner surface 131 of the positioning jig 130 by a movement mechanism (not illustrated). The second support device 160B is configured to be movable forward and backward toward the other inner surface 132 of the positioning jig 130 by a movement mechanism (not illustrated).

The first support device 160A and the second support device 160B have the same structure. Each of the first support device 160A and the second support device 160B includes a bracket 161. The bracket 161 includes a front support plate 161a and a rear support plate 161b arranged in parallel. A prismatic portion 162 is provided to penetrate through the front support plate 161a and the rear support plate 161b. A roller support portion 163 is provided at the distal end of the prismatic portion 162 facing the positioning jig 130. A drum-shaped roller 165 rotatable around the horizontally extending rotary shaft is supported by the roller support portion 163. The roller 165 of the first support device 160A is arranged so as to protrude toward the one inner surface 131 of the positioning jig 130. Accordingly, an outer circumferential surface of the roller 165 of the first support device 160A faces the inner surface 131. The roller 165 of the second support device 160B is arranged so as to protrude toward the other inner surface 132 of the positioning jig 130. Accordingly, an outer circumferential surface of the roller 165 of the second support device 160B faces the inner surface 132.

The prismatic portion 162 includes a disk-shaped boss portion 162a. The boss portion 162a is fixed to a portion of the prismatic portion 162 between the front support plate 161a and the rear support plate 161b. A spring mechanism 164 is provided between the boss portion 162a and the rear support plate 161b. The spring mechanism 164 includes a compression spring 164a provided on an outer circumference of the prismatic portion 162. The compression spring 164a is, for example, a coil spring. When a load is applied to the roller 165, the prismatic portion 162 moves rearward via the roller support portion 163, and the compression spring 164a is compressed between the boss portion 162a and the rear support plate 161b. As a result, the roller 165 elastically moves rearward. When the load applied to the roller 165 is released, the compression spring 164a elastically returns, and the prismatic portion 162 moves forward.

A threaded portion 162b is provided at a rear end of the prismatic portion 162 and penetrates through the rear support plate 161b. A nut 162c is threaded onto the threaded portion 162b. Accordingly, even when the biasing force of the compression spring 164a acts forwardly on the prismatic portion 162, the nut 162c contacts the rear support plate 161b and restricts the forward movement of the prismatic portion 162.

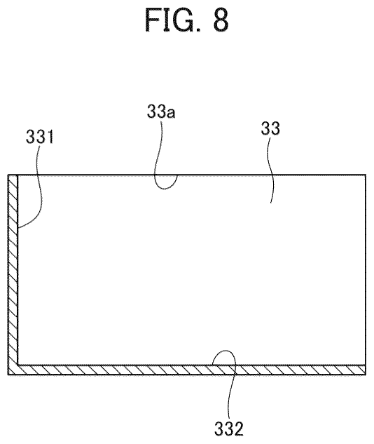

The control device 170 includes at least one processor such as a CPU (Central Processing Unit) and a memory for storing various data and programs, and controls the overall operation of the manufacturing apparatus 100. Specifically, the control device 170 controls the driving of robot motors 126 (see FIG. 7) that individually operate the arms 122 to 124 of the robot 120, thereby moving the mounting base 125 to arbitrary positions. The control device 170 captures an image of the rectangular opening 33a of the magnet insertion hole 33 photographed by the imaging device 140 and acquires, from the image, position information of two adjacent sides 331 and 332 of the opening 33a, as illustrated in FIG. 8. The two sides 331 and 332 are two mutually orthogonal sides of the opening 33a. The position information of the two sides 331 and 332 is acquired from the motor position information of the robot motors 126 that drive the arms 122 to 124, when the opening 33a is photographed by the imaging device 140. The motor position information is a detection value obtained from a position detector (not illustrated) such as an encoder provided in the robot motors 126. The control device 170 controls the operation of the drive source of the pushing device 150, thereby controlling the pushing operation of the pushing pin 151. Further, the control device 170 controls the operation of a movement mechanism of the support device 160, and controls the forward and backward movements of the first support device 160A and the second support device 160B.

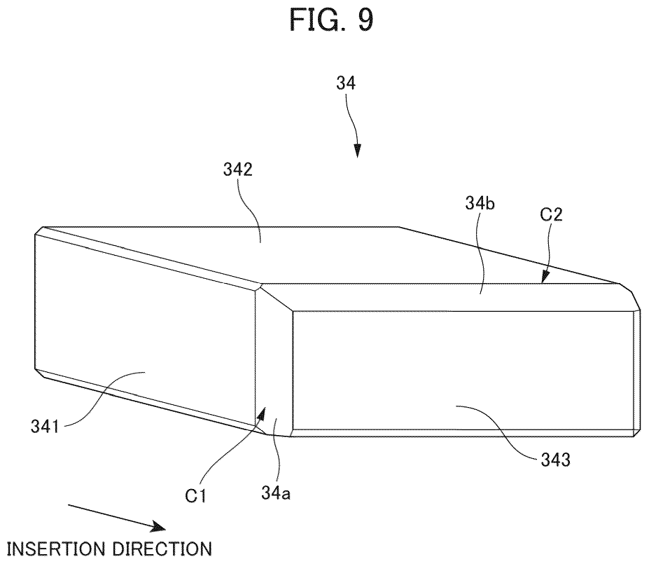

Here, the configuration of the magnet 34 will be further described with reference to FIGS. 9 to 11. As illustrated in FIG. 9, the magnet 34 has a rectangular parallelepiped shape. Accordingly, the magnet 34 includes four lateral surfaces arranged along the axial direction of the rotor 3. The axial direction of the rotor 3 is the insertion direction when the magnet 34 is inserted into the magnet insertion hole 33 of the rotor core 32. Among the four lateral surfaces, a first lateral surface 341 and a second lateral surface 342, which are adjacent to each other, are arranged so as to intersect at a right angle.

As described above, when the magnet 34 is positioned in the positioning jig 130, the first lateral surface 341 contacts one inner surface 131, and the second lateral surface 342 contacts the other inner surface 132. In the magnet 34, a corner C1 where a first lateral surface 341 intersects one end surface 343 arranged on the leading side of the magnet 34 in the insertion direction is diagonally chamfered, and a first chamfered portion 34a is formed at the corner C1. In the magnet 34, a corner C2 where a second lateral surface 342 intersects the same end surface 343 arranged on the leading side of the magnet 34 in the insertion direction is diagonally chamfered, and a second chamfered portion 34b is formed at the corner C2.

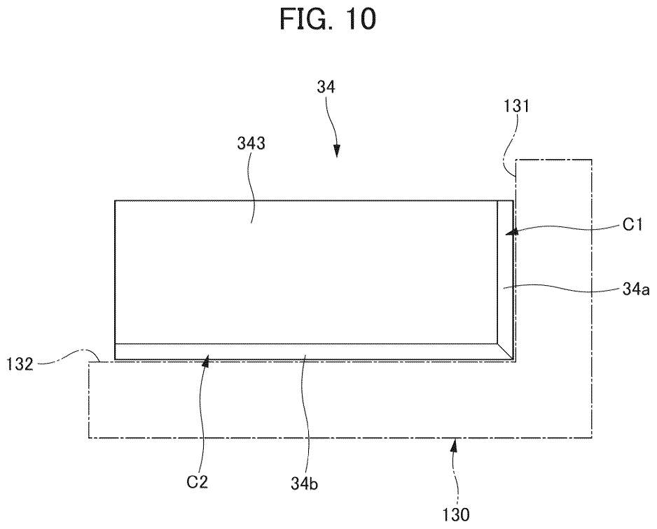

FIG. 10 is a diagram illustrating the positioning jig 130, in which the magnet 34 is positioned, as viewed from the rotor core 32 side arranged below. The end surface 343 of the magnet 34 is arranged on the leading side of the magnet 34 in the insertion direction, and is first inserted into the magnet insertion hole 33 when the magnet 34 moves along the axial direction of the rotor core 32. The first chamfered portion 34a and the second chamfered portion 34b are arranged at two orthogonal sides, among four sides of the end surface 343 of the magnet 34, the end surface being first inserted into the magnet insertion hole 33, the two orthogonal sides being arranged along two inner surfaces 131 and 132 of the positioning jig 130.

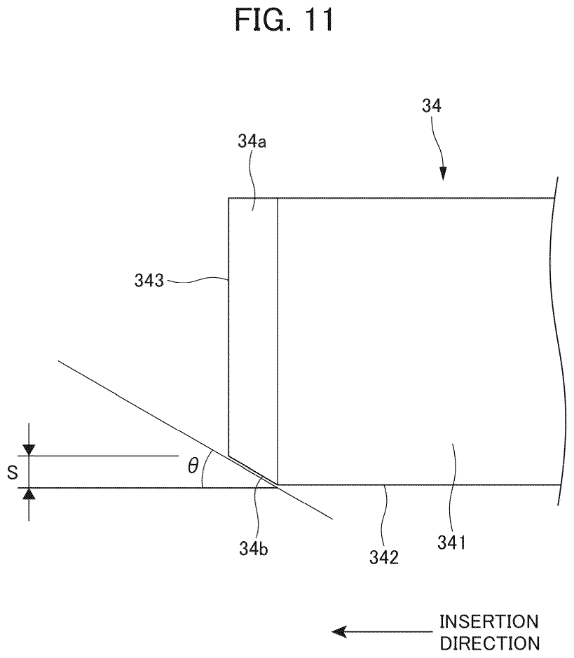

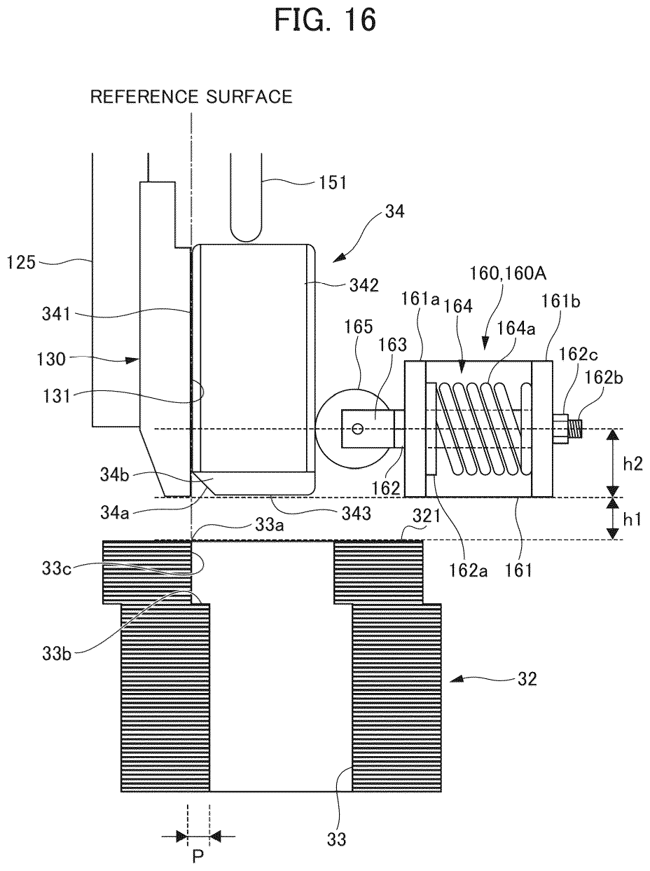

As illustrated in FIG. 11, a chamfering amount S of the first chamfered portion 34a and the second chamfered portion 34b of the magnet 34 is greater than a protruding amount P of a step portion 33b formed on an inner wall surface of the magnet insertion hole 33 (see FIG. 16). The chamfering amount S of the first chamfered portion 34a is a distance perpendicular to the first lateral surface 341, from the first lateral surface 341 to a boundary between the first chamfered portion 34a and the end surface 343. The chamfering amount S of the second chamfered portion 34b is a distance perpendicular to the second lateral surface 342, from the second lateral surface 342 to a boundary between the second chamfered portion 34b and the end surface 343. Although FIG. 11 illustrates only the chamfering amount S of the second chamfered portion 34b, the chamfering amount S of the first chamfered portion 34a and the chamfering amount S of the second chamfered portion 34b are the same. As illustrated in FIG. 16, the protruding amount P refers to the height by which a step portion 33b protrudes inward from an inner wall surface 33c of the magnet insertion hole 33, the inner wall surface being continuous with the opening 33a, when the magnet insertion hole 33 is viewed from the opening 33a. The step portion 33b may be formed due to partial positional misalignment occurring in a laminate of electromagnetic steel sheets that constitutes the rotor core 32.

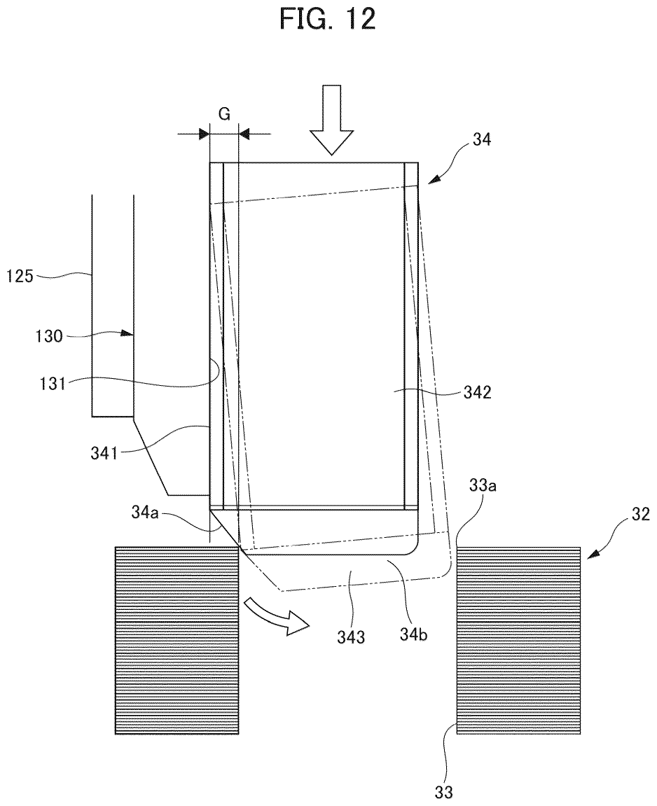

According to the magnet 34, as illustrated in FIG. 12, when the magnet 34 is inserted into the magnet insertion hole 33, a slight deviation G may occur between a position of the magnet 34 and a position of the magnet insertion hole 33.

Even in such a case, when either the first chamfered portion 34a or the second chamfered portion 34b of the magnet 34 comes into contact with the opening 33a of the magnet insertion hole 33, the magnet 34 can smoothly pass over and enter through the opening 33a. Furthermore, as illustrated in FIG. 16, even if a step portion 33c is formed inside the magnet insertion hole 33, the magnet 34 can also smoothly pass over the step portion 33c. Accordingly, the insertability of the magnet 34 into the magnet insertion hole 33 is excellent. The specific chamfering amount S of the first chamfered portion 34a and the second chamfered portion 34b of the magnet 34 is not particularly limited, but may be, for example, 0.5 mm to 1.5 mm.

As a result of the formation of the first chamfered portion 34a and the second chamfered portion 34b in the magnet 34, a rake angle θ is formed in the first chamfered portion 34a and the second chamfered portion 34b, as illustrated in FIG. 11. The rake angle θ of the first chamfered portion 34a is an angle formed between a surface of the first chamfered portion 34a and the first lateral surface 341. The rake angle θ of the second chamfered portion 34b is an angle formed between a surface of the second chamfered portion 34b and the second lateral surface 342. Although FIG. 11 illustrates only the rake angle θ of the second chamfered portion 34b, the rake angle θ of the first chamfered portion 34a and the rake angle θ of the second chamfered portion 34b are the same. A specific value of the rake angle θ of the first chamfered portion 34a and the second chamfered portion 34b is not particularly limited, but may be, for example, 40° to 50°, from the viewpoint of improving the insertability of the magnet 34.

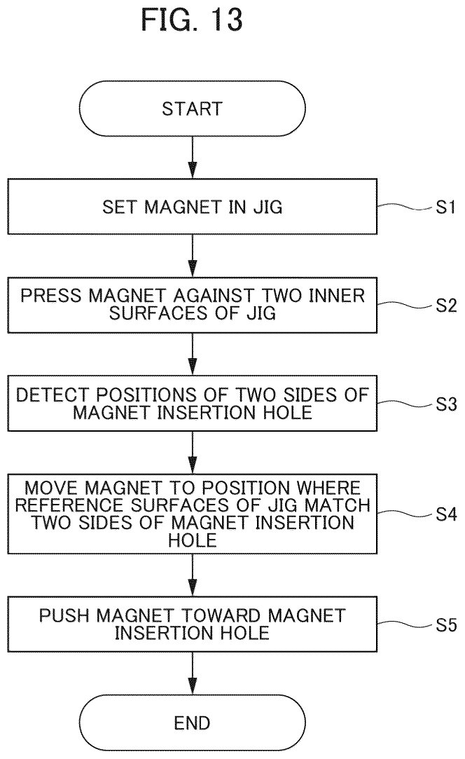

Next, the steps of manufacturing the rotor 3 by inserting the magnet 34 into the magnet insertion hole 33 of the rotor core 32 using the manufacturing apparatus 100 will be described based on the flowchart in FIG. 13.

As illustrated in FIG. 3, the rotor core 32 is placed and fixed on the placement surface 111 of the placement table 110 of the manufacturing apparatus 100. In this state, the unmagnetized magnet 34 is set on the inner surfaces 131 and 132 of the positioning jig 130 of the manufacturing apparatus 100 by an operator or by another transport device such as a robot (not illustrated) (Step S1).

As illustrated in FIG. 10, the first lateral surface 341 of the magnet 34 comes into contact with one inner surface 131 of the positioning jig 130, and the second lateral surface 342 of the magnet 34 comes into contact with the other inner surface 132 of the positioning jig 130. An end surface 343 of the magnet 34 is arranged to face downward toward the rotor core 32. The first chamfered portion 34a of the magnet 34 is aligned along one inner surface 131 of the positioning jig 130. The second chamfered portion 34b of the magnet 34 is aligned along the other inner surface 132 of the positioning jig 130.

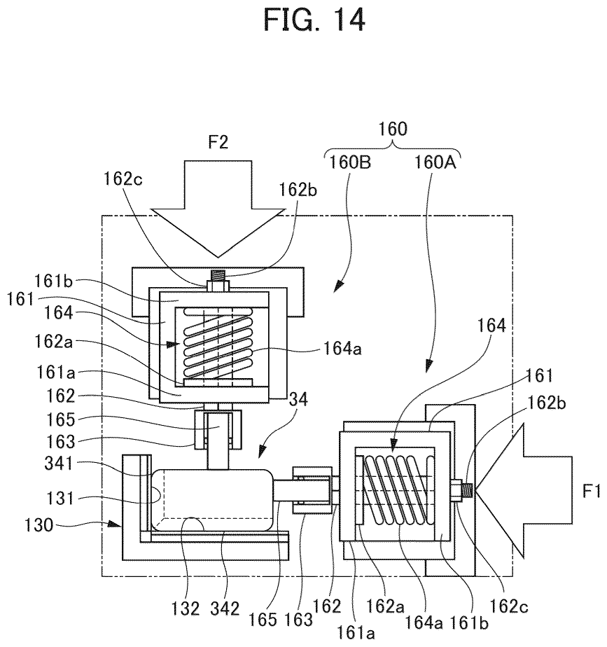

After the magnet 34 has been set on the inner surfaces 131 and 132 of the positioning jig 130, the control device 170 drives the movement mechanisms of the first support device 160A and the second support device 160B, respectively, and moves the first support device 160A and the second support device 160B forward toward the positioning jig 130. Accordingly, as illustrated in FIG. 14, the outer circumferential surfaces of the rollers 165, which are provided at respective distal ends of the first support device 160A and the second support device 160B, contact the magnet 34, whereby the first support device 160A and the second support device 160B press the magnet 34 against the two inner surfaces 131 and 132 of the positioning jig 130 with predetermined pressing forces. The first lateral surface 341 of the magnet 34 is pressed by the roller 165 of the first support device 160A, and contacts the inner surface 131 of the positioning jig 130. The second lateral surface 342 of the magnet 34 is pressed by the roller 165 of the second support device 160B, and contact the inner surface 132 of the positioning jig 130 (Step S2).

The first support device 160A and the second support device 160B cause the rollers 165, which are provided at respective distal ends thereof, to contact the first lateral surface 341 and the second lateral surface 342 of the magnet 34, and elastically press the magnet 34 against the inner surfaces 131 and 132 of the positioning jig 130 by the action of the compression springs 164a. At this time, the magnet 34 makes surface contact with the positioning jig 130, whereas the magnet 34 makes point contact or line contact with the outer circumferential surfaces of the rollers 165 of the first support device 160A and the second support device 160B. If the magnet 34 makes surface contact with the first support device 160A and the second support device 160B, it becomes uncertain whether the magnet 34 will follow the inner surfaces 131 and 132 of the positioning jig 130 or the first support device 160A and the second support device 160B. As a result, there is a concern that controllability of the positioning posture of the magnet 34 may deteriorate. However, by ensuring that the magnet 34 makes point contact or line contact with the respective rollers 165 of the first support device 160A and the second support device 160B, the first lateral surface 341 and the second lateral surface 342 of the magnet 34 can be reliably pressed against and brought in contact with the inner surfaces 131 and 132 of the positioning jig 130. Accordingly, positional deviation of the magnet 34 during positioning is suppressed, and the magnet 34 can be stably positioned.

As illustrated in FIG. 14, the first support device 160A presses the magnet 34 with a pressing load F1, and the second support device 160B presses the magnet 34 with a pressing load F2, in which the pressing loads F1 and F2 differ from each other. Either of the pressing loads F1 or F2 may be greater. For example, in a case where the pressing load F1 of the first support device 160A is greater than the pressing load F2 of the second support device 160B, the first lateral surface 341 of the magnet 34 can be reliably brought into contact with one inner surface 131 of the positioning jig 130 and positioned in that state, and the second lateral surface 342 of the magnet 34 can then be brought into contact with the other inner surface 132 of the positioning jig 130 to complete the positioning. As a result, the magnet 34 can be more stably positioned. The difference between the pressing loads F1 and F2 of the first support device 160A and the second support device 160B can be realized by providing a difference in spring constants of the compression springs 164a included in the respective spring mechanisms 164.

After the magnet 34 is positioned by the positioning jig 130, the control device 170 drives and controls the robot motors 126 to move the mounting base 125 to a position where the imaging device 140 can capture the magnet insertion hole 33 of the rotor core 32 that is a target for magnet insertion. Thereafter, as illustrated in FIG. 8, the control device 170 controls the imaging device 140 to capture an image of the opening 33a of the magnet insertion hole 33, acquires position information of the two sides 331 and 332 of the opening 33a, and confirms the positions of the two sides 331 and 332 (Step S3).

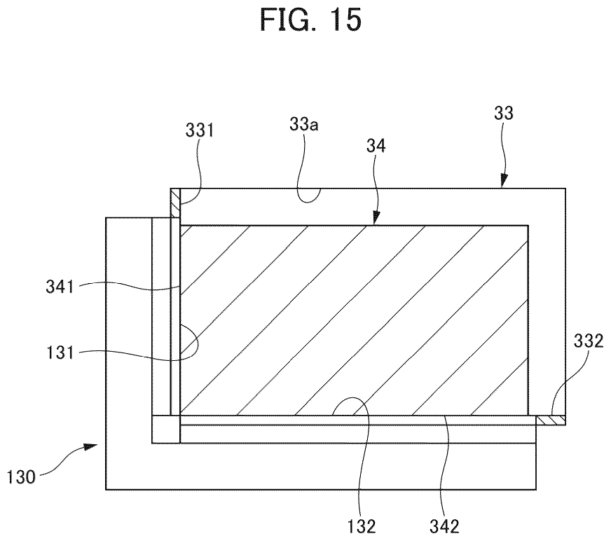

After confirming the positions of the two sides 331 and 332 of the opening 33a, the control device 170 drives and controls the robot motors 126, based on the position information of the two sides 331 and 332, and moves the mounting base 125. Accordingly, as illustrated in FIGS. 15 and 16, the magnet 34 held by the positioning jig 130 is moved to a position where the first lateral surface 341 and a second lateral surface 342 of the magnet 34 (i.e., the two inner surfaces 131 and 132 of the positioning jig 130) match the two sides 331 and 332 of the opening 33a of the magnet insertion hole 33 (Step S4).

At this time, as illustrated in FIG. 16, a distance h1 between the end surface 343 on the leading side of the magnet 34 and the upper end surface 321 of the rotor core 32 is set to a distance, for example, 5 mm, such that the magnet 34 and the rotor core 32 do not interfere with each other. A distance h2 between the end surface 343 on the leading side of the magnet 34 and the position at which the rollers 165 of the support device 160 contact the magnet 34 is set to, for example, 10 mm.

After the first lateral surface 341 and the second lateral surface 342 of the magnet 34, which come into contact with reference surfaces (i.e., inner surfaces 131 and 132) of the positioning jig 130, are aligned with the two sides 331 and 332 of the opening 33a, the control device 170 drives and controls the pushing device 150 to project a pushing pin 151, thereby pushing the magnet 34 from the positioning jig 130 toward the magnet insertion hole 33 (Step S5).

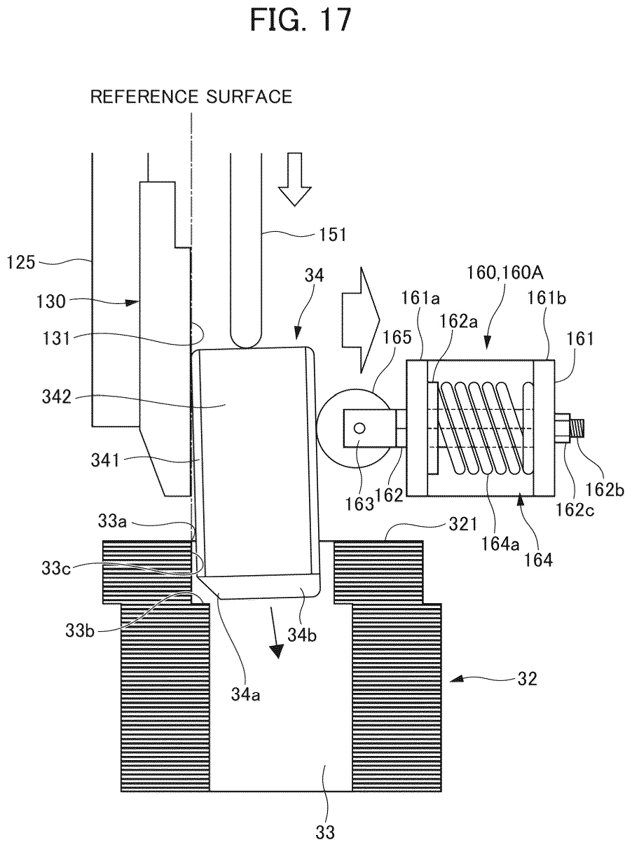

When the magnet 34 is pushed downward by the pushing pin 151, as illustrated in FIG. 17, the magnet 34 gradually moves downward while sliding along the inner surfaces 131 and 132 of the positioning jig 130, in a state of being pressed by the rollers 165 of the first support device 160A and the second support device 160B. When the lower end of the magnet 34 reaches the opening 33a of the magnet insertion hole 33, the magnet 34 is gradually inserted while the first lateral surface 341 and the second lateral surface 342 are guided along the two sides 331 and 332 of the opening 33a.

As the magnet 34 moves in the insertion direction, the two rollers 165 of the support device 160 rotate in accordance with the movement of the magnet 34. Therefore, the two rollers 165 supporting the magnet 34 do not become a resistance to the movement of the magnet 34, and the magnet 34 can be smoothly inserted into the magnet insertion hole 33.

As illustrated in FIG. 17, since the rotor core 32 is formed by laminating a plurality of electromagnetic steel sheets, a step portion 33b may be formed on the inner wall surface of the magnet insertion hole 33 due to positional misalignment between the electromagnetic steel sheets. Since the magnet 34 includes the first chamfered portion 34a and the second chamfered portion 34b formed at the two sides of the end surface 343 on the leading side in the insertion direction, even if the magnet 34 comes into contact with the step portion 33b inside the magnet insertion hole 33, the magnet 34 can easily pass over the step portion 33b by way of the first chamfered portion 34a and the second chamfered portion 34b.

When the magnet 34 passes over the step portion 33b, the magnet 34 changes posture from the vertically upright posture perpendicular to the upper end surface 321 of the rotor core 32 to a tilted posture. At this time, the magnet 34 may push back at least one of the rollers 165 of the support device 160. However, the support device 160 can elastically absorb the amount of movement of the roller 165 caused by the pushback by compression of the compression spring 164a in the spring mechanism 164. Therefore, even if the posture of the magnet 34 changes, the supported state by the roller 165 is not lost. The magnet 34 can smoothly pass over the step portion 33b while changing the posture.

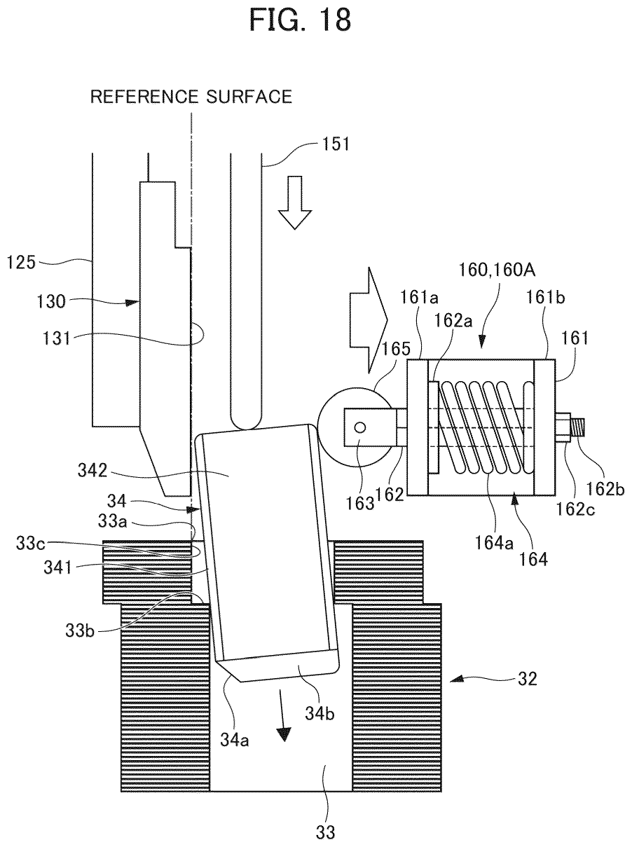

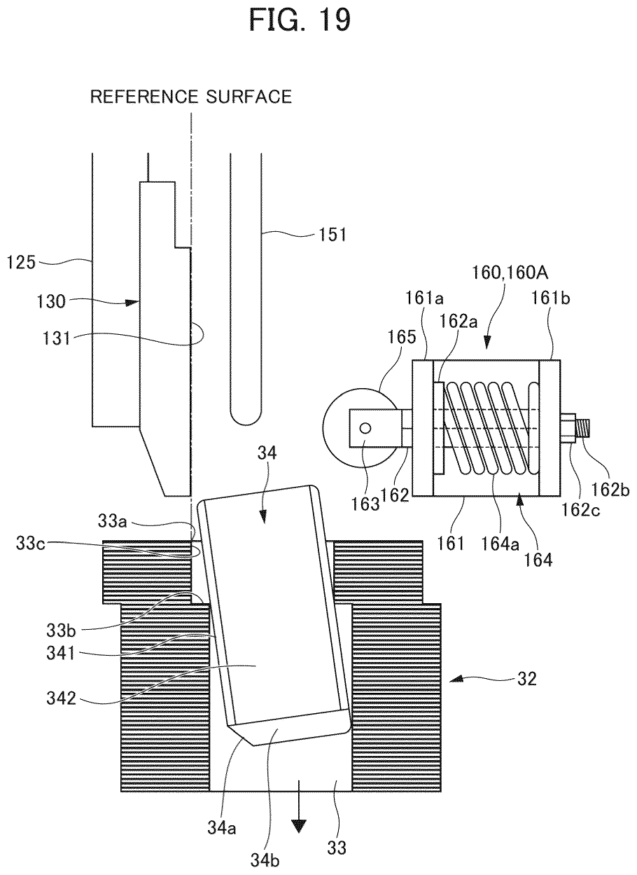

As illustrated in FIG. 18, when the magnet 34 is pushed beyond the pressing positions of the two rollers 165, support by the support device 160 is released. Thereafter, as illustrated in FIG. 19, the magnet 34 falls free inside the magnet insertion hole 33 and is completely accommodated in the magnet insertion hole 33.

According to the rotor manufacturing apparatus 100 and the method of manufacturing the rotor of the present embodiment, since the magnet 34 can be inserted into the magnet insertion hole 33 by movement in only one direction while the first lateral surface 341 and the second lateral surface 342 of the magnet 34 are aligned with the two sides 331 and 332 of the opening 33a of the magnet insertion hole 33 of the rotor 3, a range of positional deviation of the magnet 34 with respect to the magnet insertion hole 33 is reduced. Even if the gap between the magnet insertion hole 33 and the magnet 34 is reduced, the magnet 34 can be easily inserted into the magnet insertion hole 33. Therefore, an amount of a fixing material such as resin used to fix the magnet 34 in the magnet insertion hole 33 can be reduced or eliminated, and manufacturing costs can be reduced.

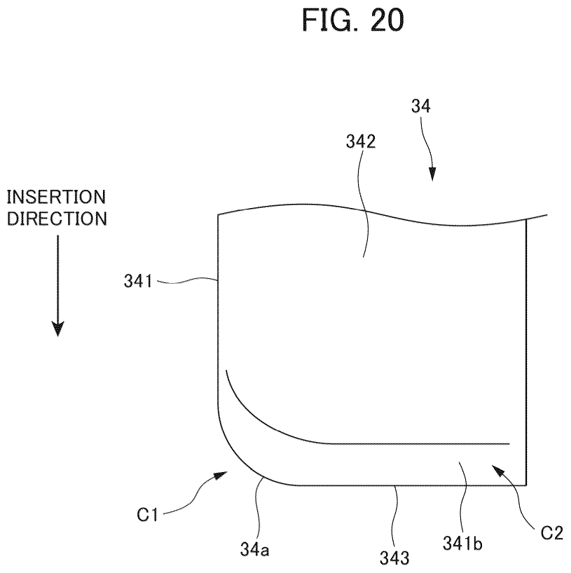

In the above embodiment, the first chamfered portion 34a and the second chamfered portion 34b of the magnet 34 are formed by diagonally chamfering the corners C1 and C2 of the magnet 34. However, as illustrated in FIG. 20, the first chamfered portion 34a and the second chamfered portion 34b of the magnet 34 may alternatively be formed by rounding the corners C1 and C2 of the magnet 34.

In the rotor manufacturing apparatus 100 of the present embodiment, the magnet 34 is positioned and supported by the positioning jig 130 using the first support device 160A and the second support device 160B, each including the drum-shaped roller 165 at the distal end. However, although not illustrated, the first support device 160A and the second support device 160B may be configured by a ball plunger including a spherical body at the distal end, instead of the rollers 165.

### EXPLANATION OF REFERENCE NUMERALS

1: rotary electric machine
3: rotor
33: magnet insertion hole
33a: opening
33c: step portion
331, 332: side
34: magnet
34a: first chamfered portion
34b: second chamfered portion
341: first lateral surface
342: second lateral surface
343: end surface
130: positioning jig
131, 132: inner surface
160: support device
C1, C2: corner
S: chamfering amount

What is claimed is:

1. A rotor of a rotary electric machine, the rotor comprising a plurality of magnet insertion holes that penetrate in an axial direction and a magnet that is inserted into a corresponding one of the plurality of magnet insertion holes,
the magnet including:
a first chamfered portion formed by chamfering a corner where a first lateral surface, among a plurality of lateral surfaces arranged along the axial direction of the rotor, intersects one end surface in the axial direction; and
a second chamfered portion formed by chamfering a corner where a second lateral surface, which is arranged adjacent to the first lateral surface among the plurality of lateral surfaces arranged along the axial direction of the rotor, intersects the one end surface in the axial direction.

2. The rotor of a rotary electric machine according to claim 1, wherein a chamfering amount of the first chamfered portion and the second chamfered portion is greater than a protruding amount of a step portion formed on an inner wall surface of each of the magnet insertion holes.

3. A method of manufacturing a rotor including a plurality of magnet insertion holes that penetrate in an axial direction and a magnet that is inserted into a corresponding one of the plurality of magnet insertion holes,
the magnet including:
a first chamfered portion formed by chamfering a corner where a first lateral surface, among a plurality of lateral surfaces arranged along the axial direction of the rotor, intersects one end surface in the axial direction, and
a second chamfered portion formed by chamfering a corner where a second lateral surface, which is arranged adjacent to the first lateral surface among the plurality of lateral surfaces arranged along the axial direction of the rotor, intersects the one end surface in the axial direction,
the method comprising:
a positioning step of positioning the magnet using a positioning jig, the positioning being based on reference surfaces defined by two inner surfaces that contact the first lateral surface and the second lateral surface of the magnet;
an alignment step of aligning the reference surfaces of the positioning jig, after the magnet has been positioned therein, with positions of two adjacent sides of an opening of the magnet insertion hole; and
an insertion step of pushing the magnet from the positioning jig and inserting the magnet into the magnet insertion hole, in a state where the positions of the reference surfaces of the positioning jig match the positions of the two sides of the opening.

4. The method of manufacturing a rotor according to claim 3, wherein a chamfering amount of the first chamfered portion and the second chamfered portion is greater than a protruding amount of a step portion formed on an inner wall surface of the magnet insertion hole.

5. The method of manufacturing a rotor according to claim 3, wherein, in the positioning step, the magnet is supported in the positioning jig by pressing the magnet against the two inner surfaces of the positioning jig using a supporter.

6. The method of manufacturing a rotor according to claim 5, wherein, in the positioning step, the magnet is elastically pressed against the two inner surfaces of the positioning jig using the supporter.

7. The method of manufacturing a rotor according to claim 5, wherein, in the positioning step, the magnet is pressed against the two inner surfaces of the positioning jig by bringing the supporter into point contact or line contact with the magnet.

8. The method of manufacturing a rotor according to claim 5, wherein, in the positioning step, different pressing forces are applied to the first lateral surface and the second lateral surface of the magnet against the two inner surfaces of the positioning jig, respectively.

9. The method of manufacturing a rotor according to claim 5, wherein, in the insertion step, a distal end of the supporter is rotated in accordance with movement of the magnet pushed toward the magnet insertion hole.
